(19) United States
(12) Patent Application Publication
(10) Pub. No.: US 2007/0265801 A1
(43) Pub. Date: Nov. 15, 2007

(54) Multivariate monitoring of operating procedures

(75) Inventors: Wendy K. Foslien, Minneapolis, MN (US); John R. Hajdukiewicz, Cambridge, MA (US)

Correspondence Address: Anthony Miologos;Honeywell International Inc., 101 Columbia Rd., P.O. Box 2245, Morristown, NJ, 07962, US

(73) Assignee: Honeywell International Inc.

(21) Appl. No.: 11/418,646

(22) Filed: May 5, 2006

(51) Int. Cl. G06F 15/00

(52) U.S. Cl. 702/182

(57) ABSTRACT

A computer implemented method, system and program product for monitoring operating procedures in a production environment. Data can be compiled indicative of an operating procedure. A plurality of executions of the operating procedure can then be analyzed. A Multiway Principal Component Analysis (MPCA) model can be utilized to detect one or more abnormalities associated with the operating procedure, in response to analyzing the plurality of executions of the operating procedure, in order to compare, monitor and diagnose an impact of variations in one or more executions of the operating procedure.

### TECHNICAL FIELD

Embodiments are generally related to data-processing devices and techniques. Embodiments are also related to techniques and systems for monitoring and managing operating procedures associated with a particular process. Embodiments are additionally related to Principal Component Analysis (PCA) and Multiway Principal Component Analysis (MPCA).

### BACKGROUND

Operating procedures are an integral part of process plant operations. Such procedures may exist in written, on-line, or automated forms. An operating procedure can be generally defined as a prescribed sequence of activities or events that have an impact on the process. Examples of procedures are startup and shutdown sequences. Variations in the execution of operating conditions impact multiple process variables, and may have financial or safety impacts on key process indicators.

The execution of an operating procedure has a desired impact on the physical process. The effectiveness of the procedure can be analyzed through monitoring key process indicators throughout the procedure. This analysis is typically done on a univariate basis. However, in chemical processes many of the variables are correlated. It is therefore believed that a need exists to improve the current monitoring and managing of operating procedures, thereby resulting in the enhanced effectiveness of such procedures. It is believed that the use of multivariate modeling to compare, monitor and diagnose the impact of variations in procedure execution can result in substantial enhancements over present univariate approaches.

### BRIEF SUMMARY

The following summary is provided to facilitate an understanding of some of the innovative features unique to the embodiments and is not intended to be a full description. A full appreciation of the various aspects of the embodiments disclosed can be gained by taking the entire specification, claims, drawings, and abstract as a whole.

It is, therefore, one aspect of the present invention to provide for improved data-processing techniques and devices.

It is yet another aspect of the present invention to provide for an improved method and system for monitoring and managing operating procedures associated with a particular process.

It is a further aspect of the present invention to provide for a method, system and program product for modeling, comparing, monitoring and diagnosing the impact of variations in procedure execution.

The aforementioned aspects of the invention and other objectives and advantages can now be achieved as described herein. A computer implemented method, system and program product for monitoring operating procedures in a production environment are disclosed. In accordance with one embodiment, implemented as a method, data can be compiled indicative of an operating procedure. A plurality of executions of the operating procedure can then be analyzed. A Multiway Principal Component Analysis (MPCA) model can be utilized to detect one or more abnormalities associated with the operating procedure, in response to analyzing the plurality of executions of the operating procedure, in order to compare, monitor and diagnose an impact of variations in one or more executions of the operating procedure. MPCA (MPCA) expands the concept of PCA to include relationships between observations over a finite time sequence. Thus, MPCA can be used to understand the variations between sets of process data over similar sequences, and locate the source of that variation.

In general, one or more statistical outputs from the MPCA model can be utilized to determine statistically unusual executions associated with the operating procedure. The operating procedure generally comprises a prescribed sequence of activities having an impact on a particular process. Example of such an operating procedure can be, for example, a start-up or shut-down sequence of the particular process. Additionally a graphical user interface can be provided, which permits a user to compare, monitor and diagnose the impact of variations in the execution(s) of the operating procedure. The disclosed embodiments thus can use a multiway principal component analysis to detect abnormalities using well-defined statistical parameters. The monitoring of the statistical outputs from the MPCA model can then be to determine statistically unusual procedure executions.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the principles of the disclosed embodiments.

FIG. 1 illustrates a block diagram of a computer system, which can be adapted for use in implementing a preferred embodiment;

FIG. 2 illustrates a block diagram of a system for implementing multivariate monitoring of operating procedures, in accordance with a preferred embodiment;

FIG. 3 illustrates a high-level flow chart of operations of a method for the development of an MPCA model for operating procedure analysis, in accordance with a preferred embodiment; and

FIG. 4 illustrates a high-level flow chart of operations of a method for the execution of an MPCA model for operating procedure monitoring, in accordance with a preferred embodiment.

### DETAILED DESCRIPTION

The particular values and configurations discussed in these non-limiting examples can be varied and are cited merely to illustrate at least one embodiment and are not intended to limit the scope of the invention.

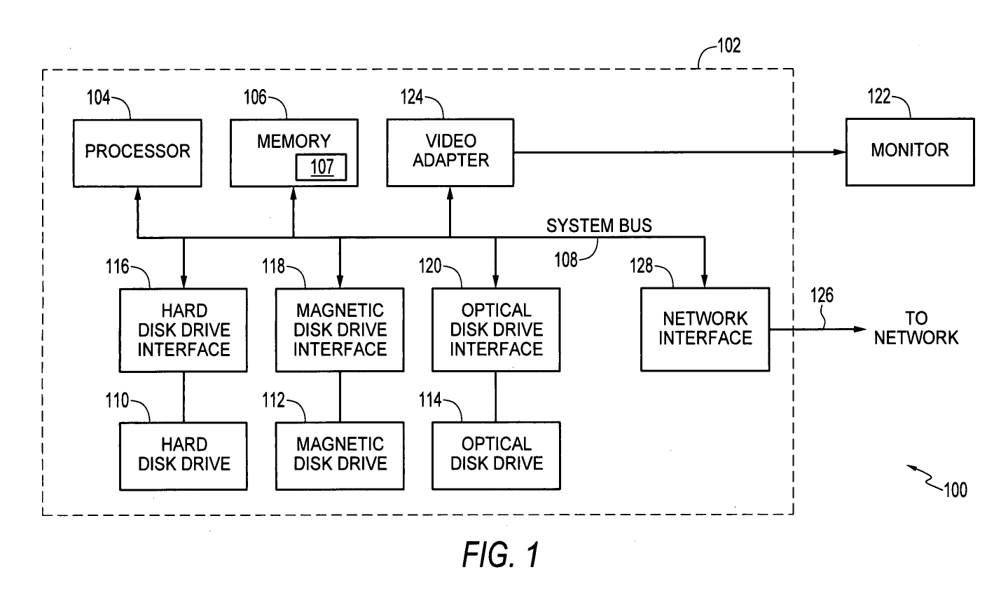

FIG. 1 illustrates a block diagram of a data-processing apparatus 100, which can be utilized to implement a preferred embodiment. Data-processing apparatus 100 can implement multivariate monitoring of operating procedures as described in greater detail herein. Data-processing apparatus 100 can be configured to include a general purpose computing device, such as a computer 102. The computer 102 includes a processing unit 104, a memory 106, and a system bus 108 that operatively couples the various system components to the processing unit 104. One or more processing units 104 operate as either a single central processing unit (CPU) or a parallel processing environment.

The data-processing apparatus 100 further includes one or more data storage devices for storing and reading program and other data. Examples of such data storage devices include a hard disk drive 110 for reading from and writing to a hard disk (not shown), a magnetic disk drive 112 for reading from or writing to a removable magnetic disk (not shown), and an optical disc drive 114 for reading from or writing to a removable optical disc (not shown), such as a CD-ROM or other optical medium. A monitor 122 is connected to the system bus 108 through an adapter 124 or other interface. Additionally, the data-processing apparatus 100 can include other peripheral output devices (not shown), such as speakers and printers.

The hard disk drive 110, magnetic disk drive 112, and optical disc drive 114 are connected to the system bus 108 by a hard disk drive interface 116, a magnetic disk drive interface 118, and an optical disc drive interface 120, respectively. These drives and their associated computer-readable media provide nonvolatile storage of computer-readable instructions, data structures, program modules, and other data for use by the data-processing apparatus 100. Note that such computer-readable instructions, data structures, program modules, and other data can be implemented as a module 107.

Note that the embodiments disclosed herein can be implemented in the context of a host operating system and one or more module(s) 107. In the computer programming arts, a software module can be typically implemented as a collection of routines and/or data structures that perform particular tasks or implement a particular abstract data type.

Software modules generally comprise instruction media storable within a memory location of a data-processing apparatus and are typically composed of two parts. First, a software module may list the constants, data types, variable, routines and the like that can be accessed by other modules or routines. Second, a software module can be configured as an implementation, which can be private (i.e., accessible perhaps only to the module), and that contains the source code that actually implements the routines or subroutines upon which the module is based. The term module, as utilized herein can therefore refer to software modules or implementations thereof. Such modules can be utilized separately or together to form a program product that can be implemented through signal-bearing media, including transmission media and recordable media.

It is important to note that, although the embodiments are described in the context of a fully functional data-processing apparatus such as data-processing apparatus 100, those skilled in the art will appreciate that the mechanisms of the present invention are capable of being distributed as a program product in a variety of forms, and that the present invention applies equally regardless of the particular type of signal-bearing media utilized to actually carry out the distribution. Examples of signal bearing media include, but are not limited to, recordable-type media such as floppy disks or CD ROMs and transmission-type media such as analogue or digital communications links.

Any type of computer-readable media that can store data that is accessible by a computer, such as magnetic cassettes, flash memory cards, digital versatile discs (DVDs), Bernoulli cartridges, random access memories (RAMs), and read only memories (ROMs) can be used in connection with the embodiments.

A number of program modules can be stored or encoded in a machine readable medium such as the hard disk drive 110, the, magnetic disk drive 114, the optical disc drive 114, ROM, RAM, etc or an electrical signal such as an electronic data stream received through a communications channel. These program modules can include an operating system, one or more application programs, other program modules, and program data.

The data-processing apparatus 100 can operate in a networked environment using logical connections to one or more remote computers (not shown). These logical connections are implemented using a communication device coupled to or integral with the data-processing apparatus 100. The data sequence to be analyzed can reside on a remote computer in the networked environment. The remote computer can be another computer, a server, a router, a network PC, a client, or a peer device or other common network node. FIG. 1 depicts the logical connection as a network connection 126 interfacing with the data-processing apparatus 100 through a network interface 128. Such networking environments are commonplace in office networks, enterprise-wide computer networks, intranets, and the Internet, which are all types of networks. It will be appreciated by those skilled in the art that the network connections shown are provided by way of example and that other means of and communications devices for establishing a communications link between the computers can be used.

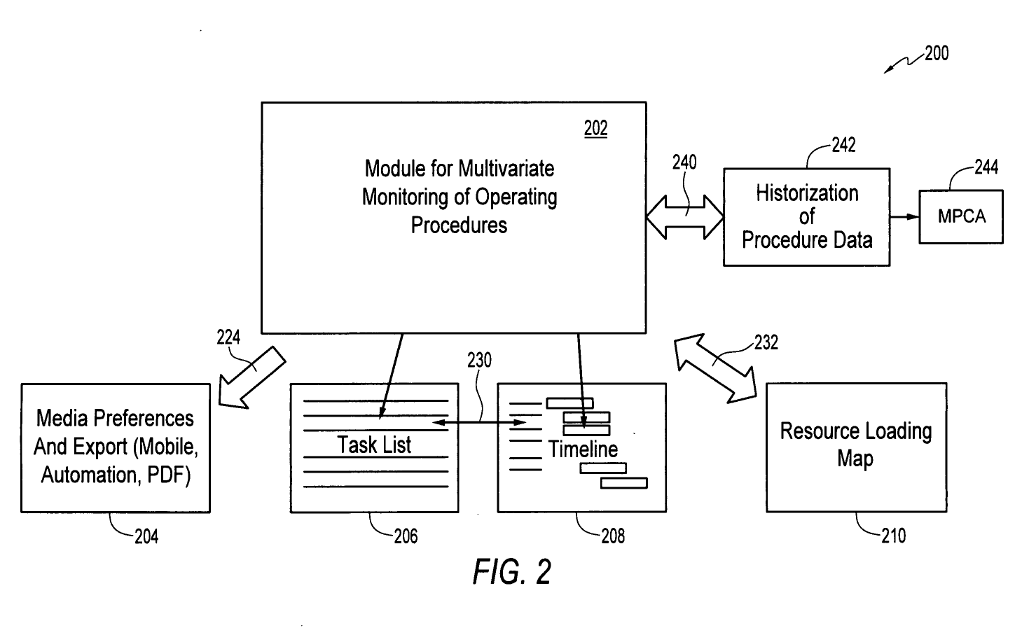

FIG. 2 illustrates a block diagram of a system 200 for implementing multivariate monitoring of operating procedures in accordance with a preferred embodiment. System 200 provides the ability to obtain or take in procedural information and interpret such information with reference to expected states and events utilizing, for example, an MPCA model 244. System 200 reflects the use of procedural content, dependencies, states, and so forth as input to, for example, the MPCA model 244. System 200 can be practiced and implemented via the data-processing apparatus 100 illustrated in FIG. 1. System 200 generally constitutes an environment for creating procedures. Such an environment can be graphical or non-graphical, depending upon design considerations.

System 200 includes a module 202 for the multivariate monitoring of operation procedures. Module 202 can be implemented as, or in place of, for example, module 107 depicted in FIG. 1. The module 202 can be executed by the data-processing apparatus 100 via, for example, processor 104. Module 202 and the data-processing apparatus 100 are operable in combination with one another to compile data indicative of an operating procedure, analyze a plurality of executions of the operating procedure; and utilize the Multiway Principal Component Analysis (MPCA) model 244 (or module) for detecting one or more abnormalities associated with the operating procedure, in response to analyzing the executions of the operating procedure, in order to compare, monitor and diagnose an impact of variations one or more executions of the operating procedure. Module 202 permits the implementation of procedural steps, dependencies, states, links to process data, data types, resource allocation, time sequencing, links to process key performance indicators, and media capture and export.

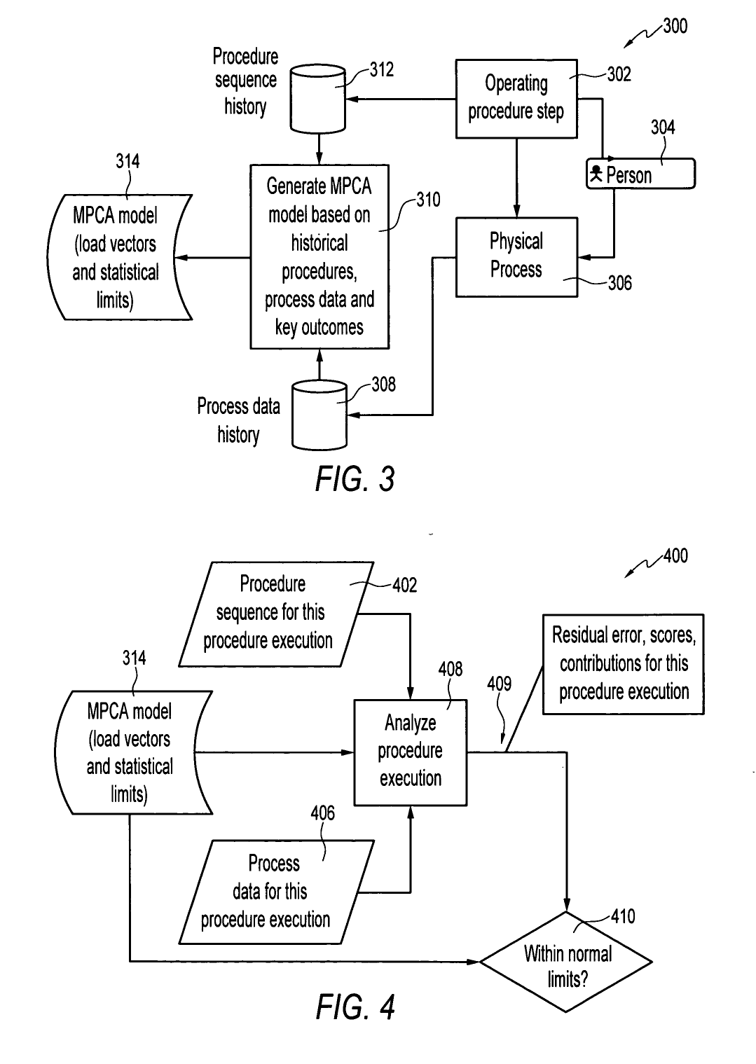

System 200 additionally includes the ability to provide for the historization of procedure data. Arrow 240 indicates that historization of procedure data can be initiated and then processed as indicated at block 242 in order to create an MPCA model, as depicted at block 244. As the procedure is executing, new data can be collected and compared with the model. Note that the procedure indicated by arrow 240 and blocks 242, 244 is described in greater detail herein with respect to FIGS. 3 and 4.

Module 202 can be utilized to provide a task list as indicated in block 206 and a timeline as indicated in block 208. The functionality depicted at block 206 can result in the generation of for example, tasks, roles and sequences of an operating procedure. The functionality depicted at block 208 can represent, for example, a timeline along with display manuals, auto, roles, times, etc. The functionalities depicted at blocks 206 and 208 can interact with one another. Arrow 230 indicates a link between the task list functionalities indicated at block 206 and the timeline functionalities illustrated at block 210.

Module 202, when activated by a user can provide the user with access to details, configurations, dependencies, resource requirements, and the like. Additionally, module 202 can be utilized to Object 214 can, for configure media preferences and permit media to be exported to other forms or formats, such as, for example, mobile, automation, PDF and so forth as indicated at block 204. Arrow 224 indicates how such media preferences and exported media formats can be generated utilizing module 202. Arrow 232, on the other hand, indicates that module 202 can provide a link to a resource loading map as indicated as depicted at block 210, which can provide a user with geographic maps, resource requirements and/or other operating procedure capabilities.

FIG. 3 illustrates a high-level flow chart illustrating logical operational steps of a method 300 for the development of an MPCA model for operating procedure analysis, in accordance with a preferred embodiment. As indicated at block 302, an operating procedure step can be implemented. Next, as depicted at block 304, an operation can be implemented in which a user inputs and/or receives data as a result of the operation depicted at block 302. Thereafter, as indicated at block 306 a physical process can be implemented. Output from the physical process described at block 306 can be provided to an operation in which data history is processed, as indicated at block 308. Next, an MPCA model can be generated based on historical procedures, process data and key outcomes, as indicated at block 308.

A procedure sequence history can also be processed, as depicted at block 312, based on information processed during the operating procedure step depicted at block 302. Information provided as a result of the operation depicted at block 312 can be utilized to generate the MPCA model as illustrated at block 310. Following processing of the operation depicted at block 310, the MPCA model can be provided, as indicated at block 314, which provides for load vectors and statistical limits. Thus, by implementing the steps depicted in FIG. 3, an MCPA model can be developed for operating procedure analysis as described herein.

The resulting MPCA model developed, as indicated by block 314, can be utilized to detect one or more abnormalities associated with the operating procedure, in response to analyzing the plurality of executions of the operating procedure, in order to compare, monitor and diagnose an impact of variations in one or more executions of the operating procedure. Note that as utilized herein the term MPCA refers generally to a mathematical procedure that can be utilized to transform the trajectories of a number of (possibly) correlated variables into a (smaller) number of uncorrelated variables called principal components. The first principal component accounts for as much of the variability in the data trajectories as possible, and each succeeding component accounts for as much of the remaining variability as possible. MPCA generally has several objectives, including the need to find or reduce dimensionality of the data set, the need to identify new meaningful underlying variables, and to model key correlation relationships between the variables over the duration of the procedure.

The PCA model described herein can be implemented in the context of a specific type of PCA technique, Multiway Principal Component Analysis (MPCA), which is an extension of PCA that can handle data in three-dimensional arrays. The module 107 and/or 202 described earlier permits a user to compile data indicative of the operating procedure, analyze the plurality of executions of the operating procedure; and utilize the Principal Component Analysis (PCA) model to detect the at least one abnormality associated with the operating procedure, in response to analyzing the plurality of executions of the operating procedure, in order to compare, monitor and diagnose the impact of variations in the at least one execution of the operating procedure.

FIG. 4 illustrates a flow chart of operations of method for the execution of an MPCA model for operating procedure monitoring, in accordance with a preferred embodiment. Note that in FIGS. 3-4, identical or similar parts or elements are generally indicated by identical reference numerals. Thus, the MPCA model 314 illustrated in FIG. 3 is also indicated in FIG. 4. Data from the MPCA model can be provided for implementing an “analyze procedure execution” step as indicated at block 408. Additionally, a procedure sequence for this procedure execution can be implemented as indicated at block 402 followed by processing of the operation described at block 408. An operation can also be provided in which data for this procedure execution is executed as indicated at block 406.

Following processing of the operation indicated at block 406, the operation illustrated at block 406 is processed. Thereafter, as indicated at block 410, a test can be performed to determine whether data generated as a result of analyzing the procedure execution as indicated at block 408 is within normal limits. Note that line 409 indicates that the data generated as a result of the operation illustrated at block 408 can contain residual errors, scores, and contributions for this procedure execution. It is this data that is analyzed to determine whether or not the procedure execution is within its normal limits, as indicated at block 410. Note that the methodology depicted in FIG. 4 can be implemented by, for example, one or more software modules, such as, for example, software module 107 and/or 202.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A computer implemented method for monitoring operating procedures in a production environment, comprising:
compiling data indicative of an operating procedure;
analyzing a plurality of executions of said operating procedure; and
utilizing a Multiway Principal Component Analysis (MPCA) model to detect at least one abnormality associated with said operating procedure, in response to analyzing said plurality of executions of said operating procedure, in order to compare, monitor and diagnose an impact of variations in at least one execution of said operating procedure.

2. The method of claim 1 further comprising monitoring a plurality of statistical outputs from said MPCA model to determine statistically unusual executions associated with said operating procedure.

3. The method of claim 1 wherein said operating procedure comprises a prescribed sequence of activities having an impact on a particular process.

4. The method of claim 3 wherein said operating procedure comprises a start-up sequence of said particular process.

5. The method of claim 3 wherein said operating procedure comprises a shut-down sequence associated with said particular process.

6. The method of claim 3 wherein said operating procedure comprises an emergency procedure associated with said particular process.

7. The method of claim 3 wherein said operating procedure comprise a normal operating procedure associated with said particular process.

8. A computer implemented system for monitoring operating procedures in a production environment, comprising:
a data-processing apparatus;
a module executed by said data-processing apparatus, said module and said data-processing apparatus being operable in combination with one another to:
compile data indicative of an operating procedure;
analyze a plurality of executions of said operating procedure; and
utilize a Multiway Principal Component Analysis (MPCA) for detecting at least one abnormality associated with said operating procedure, in response to analyzing said plurality of executions of said operating procedure, in order to compare, monitor and diagnose an impact of variations in at least one execution of said operating procedure.

9. The system of claim 8 further comprising a monitoring module for monitoring a plurality of statistical outputs from said MPCA model to determine statistically unusual executions associated with said operating procedure.

10. The system of claim 8 wherein said operating procedure comprises a prescribed sequence of activities having an impact on a particular process.

11. The system of claim 10 wherein said operating procedure comprises a start-up sequence of said particular process.

12. The system of claim 10 wherein said operating procedure comprises a shut-down sequence associated with said particular process.

13. The system of claim 10 wherein said operating procedure comprises an emergency procedure associated with said particular process.

14. The system of claim 10 wherein said operating procedure comprise a normal operating procedure associated with said particular process.

15. A program product for monitoring operating procedures in a production environment, comprising:
instruction media residing in a computer for compiling data indicative of an operating procedure;
instruction media residing in a computer for analyzing a plurality of executions of said operating procedure; and
instruction media residing in a computer for implementing a Multiway Principal Component Analysis (MPCA) model utilized to detect at least one abnormality associated with said operating procedure, in response to analyzing said plurality of executions of said operating procedure, in order to compare, monitor and diagnose an impact of variations in at least one execution of said operating procedure.

16. The program product of claim 15 further comprising instruction media residing in a computer for monitoring a plurality of statistical outputs from said MPCA model to determine statistically unusual executions associated with said operating procedure.

17. The program product of claim 15 wherein said operating procedure comprises a prescribed sequence of activities having an impact on a particular process.

18. The program product of claim 17 wherein said operating procedure comprises a start-up sequence of said particular process.

19. The program product of claim 17 wherein said operating procedure comprises a shut-down sequence associated with said particular process.

20. The program product of claim 13 wherein each of said instruction media comprises signal bearing media.
